(19) United States
(12) Patent Application Publication
(10) Pub. No.: US 2013/0183428 A1
(43) Pub. Date: Jul. 18, 2013

(54) CHOCOLATE PRODUCTS

(71) Applicants: Fabien Declercq, Mouvaux (FR); Jeroen De Paepe, Zottegem (BE); Paul Smith, Waterloo (BE)

(72) Inventors: Fabien Declercq, Mouvaux (FR); Jeroen De Paepe, Zottegem (BE); Paul Smith, Waterloo (BE)

(73) Assignee: Cargill, Incorporated, Wayzata, MN (US)

(21) Appl. No.: 13/876,240

(22) PCT Filed: Sep. 30, 2011
(86) PCT No.: PCT/EP2011/004932

§ 371 Date: Mar. 27, 2013

(30) Foreign Application Priority Data
Sep. 30, 2010 (EP) 10012012.0

(51) Int. Cl. A23G 1/30

(52) U.S. Cl. CPC A23G 1/30
USPC 426/548; 426/602; 426/519

(57) ABSTRACT

The present invention relates chocolate products comprising a water-in-oil emulsion, characterised in that: the water-in-oil emulsion comprises an aqueous phase dispersed throughout a lipid phase in the form of droplets, said droplets being encapsulated by substantially crystalline shells; and in that the aqueous phase comprises a sweetener.

### FIELD OF THE INVENTION

The invention relates to chocolate products comprising a water-in-oil emulsion and to methods of preparing such products.

### BACKGROUND OF THE INVENTION

Chocolate contains significant amounts of both sugar and fat and is therefore rich in calories. It has been a long-time objective in the chocolate industry to provide chocolate products with a reduced fat content and/or reduced calories. One approach has been to add water to chocolate products by forming emulsions with cocoa butter. Unfortunately, the preparation of such water-containing chocolates is a very difficult task: technologies that are currently available tend to have a negative impact on taste, texture, processability, stability and/or shelf-life. Even when only adding small amounts of water, this causes severe rheological changes in the product, usually accompanied by lumping and/or granulation and a coarse unacceptable mouth-feel. The addition of larger quantities of water, usually in the form of fresh cream or full cream milk, results in the production of “ganache” which is conventionally used as a short shelf-life filling for truffles or as a topping for confections. Ganache is the confectioner's term for a phase-inverted (i.e. oil-in-water) chocolate preparation and has a softer eating texture than normal chocolate and does not have the sought-after snap of traditional chocolate when broken.

In more detail, U.S. Pat. No. 5,468,509 describes a milk chocolate containing 1-16% water in which the chocolate preparation is produced by mixing cocoa butter with cocoa ingredients in the presence of an edible emulsifier, so that the ingredients are thoroughly coated with cocoa butter. The mixture is then blended with an aqueous phase prepared separately by mixing water, sweetener and milk solids to give a uniform mixture without resulting in high viscosity. The mixing is kept to a minimum speed to avoid exposing the cocoa solids in the cocoa butter to the water, whilst still producing a uniform mixture. If the cocoa solids in the cocoa butter were exposed to water, undesirable high viscosities such as gum formation and lumps of the mixed products as well as separation of the mixed products would result. Unfortunately, this slow mixing also results in an unstable product, with large water droplets, susceptible to phase separation, an undesirable mouth-feel and a much reduced shelf-life.

WO01/95737 discloses a process to overcome the fragility of the water-in-oil emulsion. Herein, a water-in-oil emulsion is prepared using equal parts of water and cocoa butter. Dark chocolate prepared by conventional methods including a conching step is melted and added thereto. This results in a dark chocolate containing 10% water. A fat suspension of milk powder is subsequently added thereto, leading to a milk chocolate containing 8% water and 23% fat, in a first embodiment. In a second embodiment, the milk chocolate contains 17% water and 30% fat. The resulting suspension turns out mouldable and demouldable so as to obtain a chocolate bar. However, no other sugar is added than the sugar present in the dark chocolate. This implies that the sugar content is reduced in the order of 30 to 50%. The cocoa content is however not substantially changed. It appears therefore that the standard cocoa-sugar ratio is not used, which likely changes the taste of the resulting chocolate.

U.S. Pat. No. 6,174,555 discloses water-containing soft coating chocolate products for use in ice-cream confectionery. To maintain a good texture even at the extreme temperatures of a frozen product, water-in-oil emulsions are produced with vegetable oils and then added to a melted chocolate product. Thus, the resulting product will in fact have a higher fat content, a poor “snap” at room temperature and, because of the vegetable oil content, cannot be labeled as chocolate.

A further process is known from J. E. Norton et al., Journal of Food Engineering, 95 (2009), 172-178. This further process comprises the preparation of a lipid composition comprising cocoa butter and an emulsifier at a temperature above the final melting point of the cocoa butter crystals. This temperature is approximately 60° C. A 20 wt % aqueous sugar solution was heated to 60° C. and thereafter added to the cocoa butter. The whole mixture was emulsified for 3 min using a high shear mixer, fitted with a fine emulsifier screen. This pre-emulsion was then pumped through a margarine line. Such margarine line comprises a first unit that comprises a stirrer with two blades, and a second unit with a stirrer comprising pins. The first unit temperature was 30° C. and the second unit temperature was 40° C. These temperatures were selected to start fat crystallisation in the first unit and to control the polymorphic form of the cocoa butter in the second unit. The mixtures were fully emulsified, with no free water. Droplets were formed with a diameter of approximately 1 micron. When the exit temperature of the second unit was in the range of 29 to 32° C., a tempered emulsion was obtained. In other words, the crystallisation occurred in the lower melting polymorphic forms of cocoa butter that are desired for a good chocolate quality.

However, Norton et al. discloses cocoa butter emulsions, with up to 20% sugar content of the aqueous solution. He does not disclose chocolate. Nearly all experiments are carried out with a 1% sugar solution, an aqueous phase of 21% and a fat content of 78%. He mentions emulsions with 50% water, but no conclusions are given thereon. Moreover, the tables 3a and 3b show that with an increase in water content the amount of water present in droplets over 100 microns size increases. For a 50% water sample, the percentage of water in droplets over 100 micron size is 34% and 73% for two different emulsifiers. As shown in table 7, the average droplet size furthermore increases with an increase water and sugar content. In other words, it appears that Norton's disclosure provides a nice basis, but does not address chocolate manufacturing with a higher sugar content. And with an increase in water and sugar content, the results are less convincing. Moreover, there is no indication that the resulting taste of the chocolate is good.

US2006/0121164 discloses chocolate products based on oil-in-water suspensions. These will inherently suffer from a number of drawbacks including reduced stability (compared to products based on water-in-oil suspensions), a dependency on structuring agents (to structure and sufficiently solidify the aqueous phase) and an undesirable texture and mouth-feel. In particular, it would be very difficult, if not imposible, to use the claimed technology to make chocolate products with a desirable “snap”.

There is therefore still a need in the market for improved emulsion-based chocolate products with a reduced fat content and/or reduced calories. The present invention addresses this need.

### SUMMARY OF THE INVENTION

According to a first aspect of the present invention, there is provided a chocolate product comprising a water-in-oil emulsion, characterised in that: the water-in-oil emulsion comprises an aqueous phase dispersed throughout a lipid phase in the form of droplets, said droplets being encapsulated by substantially crystalline shells; and in that the aqueous phase comprises a sweetener.

According to another aspect of the present invention, there is provided a method of preparing a chocolate product according to any one of the previous claims, characterised in that it comprises the steps of:

a) dispersing droplets of a sweetened aqueous composition throughout a lipid composition to form a water-in-oil emulsion; and

b) cooling the emulsion such that the droplets of aqueous composition are encapsulated in substantially crystalline shells.

### DETAILED DESCRIPTION

The present invention provides a new and improved chocolate product that has a reduced fat content and/or a reduced sugar content. The term “chocolate product” (or “chocolate”) as used herein may refer to any type of chocolate mass (milk, dark or white for instance), chocolate coating, chocolate filling, soft chocolate chunks, chocolate spread and so on for use in any desirable applications (confectionary, bakery, chilled or frozen desserts such as ice-cream, etc).

Dark chocolate products typically comprise a mixture of cocoa liquor, cocoa powder, cocoa butter, cocoa butter equivalents and/or cocoa butter substitutes, sugar and/or sugar substitutes, and one or more emulsifiers. They may also include milk fat. Milk chocolate products will also comprise milk fat together with milk solids (such as milk powder). White chocolate will not include cocoa liquor or cocoa powder but, like milk chocolate, will include milk fats and milk solids. All chocolate products may include additional ingredients such as flavoring agents, coloring agents and/or texturizing agents. They may also comprise so-called inclusions such as nut products, fruit products, cereal products, and so on. Certain chocolate products may also include water.

The chocolate product of the present invention comprises water in the form of a water-in-oil emulsion. In particular, the chocolate product of the present invention comprises a water-in-oil emulsion, characterised in that:
the water-in-oil emulsion comprises an aqueous phase dispersed throughout a lipid phase in the form of droplets, said droplets being encapsulated by substantially crystalline shells; and in that
the aqueous phase comprises a sweetener.

The emulsion will preferably comprise up to 60% water, preferably 5-50% water, more preferably 10-40% water, more preferably 15-30% water by weight based on the total weight of the emulsion. Conversely, this means that the lipids may account for as little as 40%, preferably 50-95%, more preferably 60-90%, more preferably 70-85% of the emulsion by weight.

### The Lipid Phase

The lipid phase is formed from a lipid composition. The constituents of the lipid composition will be selected by a skilled person depending on the nature of the chocolate product being produced. Thus, for a chocolate spread for example, it will be desirable to include oils and/or fats with a lower melting point. For a hard or mouldable chocolate product, the skilled person will favour fats with a higher melting point, preferably fats that are solid at room temperature. Advantageously, the lipid composition will comprise lipids selected from the group consisting of: cocoa butter, cocoa butter alternatives (such as cocoa butter equivalents, cocoa butter substitutes or cocoa butter replacers), milk fat, anhydrous milk fat, and mixtures of two or more thereof. Cocoa butter alternatives may include, for instance, hydrogenated and non-hydrogenated vegetable fats such as palm or coconut oil, interesterified palm or coconut oil, or palm or coconut oil fractions. The lipid composition may also comprise modified cocoa butter (such as interesterified cocoa butter) and/or cocoa butter fractions. For instance, it may comprise fractionated cocoa butter stearins. According to one particular embodiment, it will comprise stearin fractions from interesterified cocoa butter, preferably from enzymatically interesterified cocoa butter. In any event, the lipid composition should comprise one or more fats capable of forming substantially crystalline shells around the aqueous droplets of the aqueous phase.

In a preferred embodiment of the invention, the lipid composition will consist of cocoa butter and anhydrous milk fat. When anhydrous milk fat is used, it will preferably be used in an amount of at least 3% by weight, preferably of 5 to 20% by weight, based on the total weight of the lipid composition. For white chocolate products, the use of more than 5% by weight milk fat will be deemed particularly beneficial, with amounts of 10 to 20% by weight being preferred.

The lipid phase may comprise one or more additional ingredients. These ingredients are not strictly speaking part of the lipid composition (not being lipids themselves) but will preferably be dispersed therein. They may include, for instance, cocoa powder, cocoa liquor and/or cocoa mass, milk solids (e.g. milk powder or defatted milk powder), whey proteins and/or soy milk proteins, flavoring agents (such as vanilla or vanillin), emulsifiers (such as lecithin or polyglycerol polyricinoleate, PGPR) and possibly some additional sweetener. Preferably, the chocolate products of the present invention will include cocoa powder and an emulsifier. For milk and white chocolates, it will also be preferred to add defatted milk powder to the lipid phase.

### The Aqueous Phase

The aqueous phase is formed from an aqueous composition. The aqueous composition will typically be a water-based composition characterized in that it comprises a sweetener. The sweetener may be, for example, a crystalline, powder or liquid sweetener. Advantageously, the sweetener will be selected from the group consisting of: sugars, amorphous sweeteners, polyols, high intensity sweeteners and mixtures thereof. Any sugar, such as a monosaccharide or a disaccharide, can be used. Examples include sucrose, fructose and/or glucose (either in dry form or in the form of a syrup). Examples of amorphous sweeteners to include honey, maple syrup and/or molasses. Examples of suitable polyols include sorbitol, erythritol, lactitol, xylitol and/or mannitol, with erythritol being particularly preferred. Examples of high intensity sweeteners include aspartame, sucralose, stevia-based sweeteners (such as Truvia®) and the like. Of course, any combination of the above sweeteners may also be used. For example, in order to reduce the caloric value of the chocolate product, a mixture of a polyol and sugar may be used.

Advantageously, by encapsulating the aqueous phase, and therefore the sweetener, in a substantially crystalline shell, the present invention addresses a number of problems in the art. For example, the cooling effect typically associated with polyols such as erythritol or xylitol can be limited or avoided by pre-dissolving them in the aqueous composition prior to incorporation in the chocolate product. Similarly, processing difficulties typically observed when trying to incorporate viscous sweeteners such as honey can be avoided as they too can be pre-dissolved in the aqueous composition. What's more, by encapsulating the one or more sweeteners in a substantially crystalline shell, certain undesirable flavors (such as the liquorish flavor normally associated with stevia-based sweeteners) may be masked.

When the sweetener is a crystalline sugar, it will preferably be included in the aqueous phase in an amount of at least 25% by weight, preferably 25-60% by weight, more preferably 25-40% by weight, based on the total weight of the aqueous composition. Other sweeteners, such as artificial or high-intensity sweeteners, will preferably be used in an amount sufficient to give a sweetness corresponding to a content of at least 25% crystalline sugar by weight. Of course, the exact sweetener content will be determined by a person skilled in the art depending on the desired sweetness of the final chocolate product.

The sweetener may be present in the aqueous phase in any form. For example, it may be dissolved, partially dissolved, dispersed or suspended in the aqueous phase. Preferably, it will be at least partially dissolved.

The aqueous phase may also comprise a milk product. The milk product may a skimmed, partially skimmed or whole milk product, preferably selected from the group consisting of: milk itself, dehydrated or partially dehydrated milk (e.g. evaporated or sweetened condensed milk), milk powder, cream, soy milk products and mixtures of two or more thereof. The one or more milk products included in the aqueous phase will preferably not include milk fat. Advantageously, the milk product will be a skimmed milk product. Where milk itself is used, it may be used in combination with water to form the aqueous composition or it may be used alone (i.e. without water).

If used, milk will be included in the aqueous phase in an amount of at least 25% by weight, based on the total weight of the aqueous composition. Other milk products will preferably be included in an amount which corresponds to a milk content of at least 25% by weight, as would be readily determined by the skilled person.

Other optional ingredients may also be included in the aqueous phase. These may include flavouring agents, gelling agents, nutraceuticals such antioxidants, vitamins, minerals, and so on.

The aqueous composition will be included in the chocolate products of the present invention in the form of an aqueous phase dispersed throughout the lipid phase in the form of droplets. The droplets will preferably be small in size. Advantageously they will have an average diameter of no more than 30 μm, preferably of no more than 20 μm, more preferably of no more than 15 μm. According to certain embodiments, the droplets may have an average diameter as small as 0.1 μm, 0.5 μm or 1 μm. According to one possible embodiment, the droplets will have an average diameter of 2-15 μm, preferably of 5-15 μm. This small droplet size is preferably achieved by high speed or high shear mixing of the aqueous phase and the lipid phase.

### Method

A method of preparing a chocolate product as described above is also part of the present invention. The method will comprise at least the following steps:

a) dispersing droplets of a sweetened aqueous composition throughout a lipid composition to form a water-in-oil emulsion; and

b) cooling the emulsion such that the droplets of aqueous composition are encapsulated in substantially crystalline shells.

The sweetened aqueous composition is prepared by mixing together a sweetener and an aqueous composition (both as described above). The sweetener will preferably be fully or partially dissolved in the aqueous composition before use. Other option ingredients may also be added, mixed, suspended and/or dissolved into the aqueous composition as required.

If necessary, i.e. if more than one lipid is going to be used to form the lipid composition, it will be prepared by blending the selected lipids prior to step (a). If one or more additional ingredients (e.g. solids such as cocoa powder) are to be dispersed throughout the lipid phase, this may be done prior to, during or after step (a).

Step (a) will preferably be achieved by high speed or high shear mixing of the lipid and aqueous compositions. The terms “high speed” or “high shear mixing” as used herein will preferably refer to mixing at a rotation speed of 100 rpm or more, more preferably of 200 to 5000 rpm, more preferably still of 500 to 2000 rpm. According to one embodiment, the mixing speed may be 1000-2000 rpm. Alternatively, the mixing speed could be as low as 100-200 rpm. Preferably, use will be made of a scraped-surface heat exchanger. This is embodied, for instance, in the use of equipment typically used for the production of margarine, e.g. Schröder equipment. In this respect, reference is made to J. E. Norton et al. J. Food Engineering, 95 (2009), 172-178, included herein by reference.

Mixing will be continued until the aqueous phase is fully and homogeneously dispersed throughout the lipid phase. Ideally, the lipid and aqueous phase will be mixed for at least 30 seconds, preferably for 30 seconds to 3 minutes, more preferably for 1 to 2 minutes.

To ensure ease of mixing, the lipid composition should be in a liquid state during step (a). Thus, step (a) will advantageous be performed at or above the melting point of the lipid composition, preferably at a temperature of 35° C. or more. For example, step (a) may be performed at a temperature in the range of 45-70° C. Advantageously, it will be performed at a temperature in the range of 55-65° C.

Once mixing is complete, the emulsion can be cooled. It will preferably be cooled until a temperature of at least 25 to 35° C. Upon cooling, the lipids of the lipid phase will begin to crystallise, thereby forming a lipid matrix around the dispersed aqueous droplets. Lipid crystallisation is a critical step in the manufacture of chocolate products and is important for both mouth-feel, stability and shelf-life (bloom-resistance). As such, step (b) may not be a straight cooling process (i.e. wherein the temperature is gradually decreased) but may include a tempering phase. Tempering is a process which is well known in the art and which uses temperature cycling (heat decreases and increases) to ensure optimum crystal formation. To ensure homogenous crystal formation, the emulsion will preferably continue to be stirred during step (b). Stirring during step (b) may—but will not necessarily—be performed at high speeds, such as those described above in relation to step (a). Preferably, step (b) will be performed while stirring at 100 to 800 rpm, more preferably at 200 to 800 rpm.

Once a temperature of 25 to 35° C. has been reached, the emulsion will be allowed to solidify. This can be achieved by further cooling (e.g. in a fridge) or by allowing the emulsion to set at room temperature. In view of the likely viscosity of the emulsion at lower temperatures, the solidification step will not require stirring. Thus, if any additional ingredients need to be added to the chocolate product after step (a), they will advantageously be added prior to the solidification step.

### Chocolate Products

The products of the present invention (or obtained by the method of the present invention) may include, as noted above, chocolate mass (milk, dark or white), chocolate coating, chocolate filling, soft chocolate chunks, chocolate spreads and so on. They may be used, just like any other chocolate products, in any number of applications. They may, for instance, be shaped or moulded (e.g. for producing chocolate bars, chocolate tablets or moulded chocolate shapes). They may be packaged and used as such (e.g. as a chocolate paste, spread or dipping). Alternatively, they may be included as a component of another product. For instance, they may be used in confectionary products (e.g. as a coating or shell or as a filling or ganache for pralines, truffles and the like), in bakery products (e.g. as chocolate chunks, flakes or drops for biscuits, cookies or cakes), or in chilled or frozen desserts (e.g. as coatings or as inclusions for ice-cream).

As described above, the chocolate products of the present invention comprise a water-in-oil emulsion characterized in that droplets of the aqueous phase, dispersed throughout a lipid phase, are encapsulated by substantially crystalline shells. The shells, formed by crystallisation of the lipid phase around the droplets, should be intact and stable (i.e. 100% solid at room temperature). Advantageously, it has been found that, because of their small size, the encapsulated shells are not detected during consumption, meaning that they do not lead to grittiness and are too small for the consumer to notice the presence of a liquid. Thus, the products of the present invention have been found to have a good mouth-feel. They are also highly stable and, advantageously, will not suffer from phase separation upon storage.

They also have a good flavor. A very fatty flavor or mouth-feel is generally undesirable and, as such, the chocolate products of the present invention will preferably comprise a maximum of 50% lipids by weight, more preferably a maximum of 40% by weight, more preferably a maximum of 30% lipids by weight, based on the total weight of the chocolate product.

These and other aspects of the present invention will now be further described with reference to the following, non-limiting examples.

### EXAMPLES

In the following examples, a series of chocolate products were produced with the ingredients as set out in Table 1. All of the ingredients were standard, commercially available products. The cocoa butter was obtained from Cargill (Gerkens Cacao type PPP). The fine cocoa mass was obtained from Cargill (Cargill Gerkens Cacao WAF01, West-African Cocoa Beans).

### Lab Scale

Milk, white and dark chocolate products were prepared as follows: the lipid composition was prepared by melting the cocoa butter and the emulsifier using a water bath, mixing and then adding any further ingredients, e.g. cocoa mass, anhydrous milk fat and/or dry defatted milk powder. The temperature of the water bath was 60° C. The aqueous composition was prepared by mixing together the various ingredients at 60° C. It was then added to the lipid composition and mixed using a high shear mixer with a rotation speed of 1000-2000 rpm. The addition and mixing occurred at 60° C. and was carried out in a double jacket heater. Once emulsion was achieved, the temperature was gradually decreased to approximately 25° C. To increase the speed of crystal formation and therefore emulsion stabilization the emulsion was cooled in a fridge.

The products were tested and then stored at 6-8° C. or at ˜18° C. for 24 hours to evaluate hardness and stability.

### Schroder Equipment

A further sample of milk chocolate (with the same recipe) was produced at the pilot plant scale (using Schroder equipment): the lipid composition was prepared by melting the cocoa butter and the emulsifier in an oven at 60° C., mixing and then adding any further ingredients, e.g. cocoa mass, anhydrous milk fat and/or dry defatted milk powder. The mixture was made in a double jacket vessel and kept at 60° C. The aqueous composition was prepared by mixing together the various ingredients at 60° C. It was then added to the lipid composition and mixed using a high shear mixer with a rotation speed of 200-1000 rpm. The addition and mixing occurred at 60° C. and was carried out in a double jacket heater. Once emulsion was achieved, the temperature was gradually decreased to approximately 25° C. During cooling, the emulsion continued to be stirred at a rate between 200 and 800 rpm.

The milk chocolate products were tested, as above, and found to have very similar properties to those produced at the lab scale.

### Results

The products obtained were all evaluated for hardness, texture/mouth-feel and calorie content. As will be apparent to a person skilled in the art, the different products will be suitable for use in different applications. S1 and S2, for instance, remained soft even after storage at 6-8° C. for 24 h. In fact, S2 remained soft even after storage at −18° C., indicating that it would be particularly suitable for use in frozen desserts, e.g. as an inclusion in ice-cream. All of the products had a good texture. S3 and S4 were particularly creamy and S6 was very smooth. Compared to standard chocolates, all the samples also benefited from a significant calorie reduction.

TABLE 1
recipes

| | Ingre- | Chocolate Product Type | | | | | |
|---|---|---|---|---|---|---|---|
| compo- | dient | White | | Milk | | Dark | |
| sition | (wt %) | S1 | S2 | S3 | S4 | S5 | S6 |
| lipid | cocoa | 20 | 28.7 | 24.7 | 29.0 | 14.0 | 12.0 |
| | butter | | | | | | |
| | fine | 0 | 0 | 15.0 | 8.0 | 42 | 36 |
| | cocoa | | | | | | |
| | mass | | | | | | |
| | anhy- | 4 | 3.5 | 3.5 | 3.5 | 0 | 0 |
| | drous | | | | | | |
| | milk fat | | | | | | |
| | milk | 0 | 5 | 0 | 0 | 0 | 0 |
| | powder * | | | | | | |
| | PGPR | 0.8 | 0.8 | 0.8 | 0.8 | 0.8 | 0.68 |
| | emul- | | | | | | |
| | sifier | | | | | | |
| aque- | sugar | 35.3 | 22.0 | 26.3 | 27.6 | 28.70 | 24.60 |
| ous | water | 20.3 | 17.0 | 15.1 | 15.9 | 14.5 | 26.70 |
| | milk | 19.6 | 28.0 | 14.6 | 15.3 | 0 | 0 |
| | powder | | | | | | |
| | vanilla | 0 | 0.05 | 0 | 0 | 0 | 0 |
| | sucra- | 0 | 0.03 | 0.02 | 0.02 | 0.02 | 0.02 |
| | lose | | | | | | |
| | type of | C | P | C | C | — | — |
| | milk ** | | | | | | |

| | | | | | | |
|---|---|---|---|---|---|---|
| Calories per 100 g | 433 | 483 | 504 | 510 | 492 | 421 |
| (in kcal) | | | | | | |
| Calorie | 134 | 84 | 10 | 40 | 33 | 104 |
| reduction *** | | | | | | |

* milk powder = dry defatted milk powder.
** ‘C’ refers to condensed skimmed milk; ‘P’ refers to milk prepared from defatted dry milk powder and water.
*** calorie reduction (in kcal) per 100 g compared, like for like, to standard white chocolate (567 kcal/100 g), milk chocolate (550 kcal/100 g) and dark chocolate (525 kcal/100 g).

1.-15. (canceled)

16. A chocolate product comprising:
a water-in-oil emulsion,
wherein the water-in-oil emulsion comprises an aqueous phase dispersed throughout a lipid phase in the form of droplets, the droplets being encapsulated by substantially crystalline shells, and wherein the aqueous phase comprises a sweetener.

17. The chocolate product of claim 16, wherein the aqueous phase further comprises a milk product.

18. The chocolate product of claim 16, wherein the droplets have an average diameter of no more than 30 μm.

19. The chocolate product of claim 16, wherein the lipid phase comprises a fat selected from the group consisting of a cocoa butter, a modified cocoa butter, a cocoa butter fraction, a cocoa butter alternative, a milk fat, an anhydrous milk fat, and mixtures thereof.

20. The chocolate product of claim 16, wherein one or more solids are dispersed throughout the lipid phase.

21. The chocolate product of claim 16, wherein the emulsion comprises up to 60% water by weight, based on the total weight of the emulsion.

22. The chocolate product of claim 16, wherein the sweetener is selected from the group consisting of a sugar, an amorphous sweetener, a polyol, a high intensity sweetener, and mixtures thereof.

23. A method of preparing the chocolate product of claim 16, the method comprising:
a) dispersing droplets of a sweetened aqueous composition throughout a lipid composition to form a water-in-oil emulsion; and
b) cooling the emulsion such that the droplets of the sweetened aqueous composition are encapsulated in substantially crystalline shells.

24. The method of claim 23, wherein step (a) comprises mixing the aqueous composition and the lipid composition at a rotation speed of at least 100 rpm.

25. The method of claim 23, wherein step (a) comprises mixing the aqueous composition and the lipid composition at a rotation speed of at least 200 rpm.

26. The method of claim 23, wherein step (a) is performed at or above the melting point of the lipid composition.

27. The method of claim 23, further comprising dispersing one or more solids throughout the lipid phase.

28. The method of claim 23, wherein step (b) comprises cooling the emulsion to a temperature of 25° C. to 35° C.

29. The method of claim 23, wherein step (b) includes a tempering phase.

30. The method of claim 23, wherein the emulsion is stirred during step (b).

31. The method of claim 23, wherein step (b) is followed by a solidification step.
